(19) United States
(12) Patent Application Publication
(10) Pub. No.: US 2011/0010086 A1
(43) Pub. Date: Jan. 13, 2011

(54) PORTABLE ELECTRONIC DEVICE AND PRICE COMPARISON SYSTEM AND METHOD USING THE SAME

(75) Inventor: Yi-Ting LIU, Taipei (TW)

Correspondence Address: RABIN & Berdo, PC, 1101 14TH STREET, NW, SUITE 500, WASHINGTON, DC, 20005, US

(73) Assignee: INVENTEC APPLIANCES CORP., Taipei (TW)

(21) Appl. No.: 12/833,269

(22) Filed: Jul. 9, 2010

(30) Foreign Application Priority Data
Jul. 10, 2009 (TW) 98123511

(51) Int. Cl. G06Q 30/00; G01C 21/00; G06K 19/06

(52) U.S. Cl. 701/201; 235/375; 705/27.1

(57) ABSTRACT

A price comparison system including a portable electronic device and a server is provided. The portable electronic device includes a communication module and a display module. The communication module is used for transmitting location information and merchandise information and for receiving price comparison information. The display module is used for displaying the price comparison information. The server is used for producing the price comparison information according to the location information and the merchandise information, and for transmitting the price comparison information to the communication module through wireless transmission. The location information corresponds to an area, the merchandise information corresponds to at least a product of merchandise, and the price comparison information is about prices of the product of merchandise in several shops in the area.

This application claims the benefit of Taiwan application Serial No. 098123511, filed Jul. 10, 2009, the subject matter of which is incorporated herein by reference.

### BACKGROUND OF THE INVENTION

1. Field of the Invention

The invention relates in general to a portable electronic device and price comparison system and method using the same, and more particularly to a portable electronic device providing the price comparison information of the product in several shops in an area and price comparison system and method using the same.

2. Description of the Related Art

As the distribution channels of merchandise increase largely, a consumer can purchase his/her desired products in various shops according to his/her preferences and needs. In general, different shops may have different prices for the same product. For example, during some special festivals, warehouse stores could have a part of the products be discounted to attract consumers.

In order to purchase the product at lower prices, the consumer may check and compare the prices of the product from one shop to another shop. Usually, the consumer has to spend a large amount of time. Thus, how to conveniently provide the consumer with the data of various kinds of products has become a task for the industries.

### SUMMARY OF THE INVENTION

The invention is directed to a portable electronic device and price comparison system and method using the same for providing consumers with a comparison price of the product in each shop in an area. Therefore, the consumer's time spent on comparing the prices can be effectively saved. In terms of the vendors, the present invention also provides benefits of advertisement and marketing.

According to a first aspect of the present invention, a price comparison system including a portable electronic device and a server is provided. The portable electronic device includes a communication module and a display module. The communication module is used for transmitting location information and merchandise information and for receiving price comparison information. The display module is used for displaying the price comparison information. The server is used for producing the price comparison information according to the location information and the merchandise information, and for transmitting the price comparison information to the communication module through wireless transmission. The location information corresponds to an area, the merchandise information corresponds to at least a product of merchandise, and the price comparison information is about prices of the product of merchandise in several shops in the area.

According to a second aspect of the present invention, a portable electronic device used for communicating with a server is provided. The portable electronic device includes a communication module and a display module. The communication module is used for transmitting location information and merchandise information and for receiving price comparison information. The price comparison information is produced by the server according to the location information and the merchandise information. The display module is used for displaying the price comparison information. The location information corresponds to an area, the merchandise information corresponds to at least a product of merchandise, and the price comparison information is about prices of the product of merchandise in several shops in the area.

According to a third aspect of the present invention, a price comparison method including the following steps is provided. Price comparison information is produced according to location information and merchandise information, wherein the location information corresponds to an area, the merchandise information corresponds to at least a product of merchandise, and the price comparison information is about prices of the product of merchandise in several shops in the area. Next, the price comparison information is displayed through a portable electronic device.

The invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of a price comparison system according to an embodiment of the present invention.

FIG. 2 shows an example of the portable electronic device in FIG. 1 carried and located in the area.

FIG. 3 shows a flowchart of a price comparison method according to the present invention.

FIG. 4 shows a flowchart of a price comparison method according to an embodiment of the present invention.

### DETAILED DESCRIPTION OF THE INVENTION

The price comparison system of the present invention includes a portable electronic device and a server. The portable electronic device includes a communication module and a display module. The communication module is used for transmitting location information and merchandise information and for receiving price comparison information. The display module is used for displaying the price comparison information. The server is used for producing the price comparison information according to the location information and the merchandise information, and for transmitting the price comparison information to the communication module through wireless transmission. The location information corresponds to an area. The merchandise information corresponds to at least a product of merchandise. The price comparison information is about prices of the product of merchandise in several shops in the area. An embodiment is exemplified below.

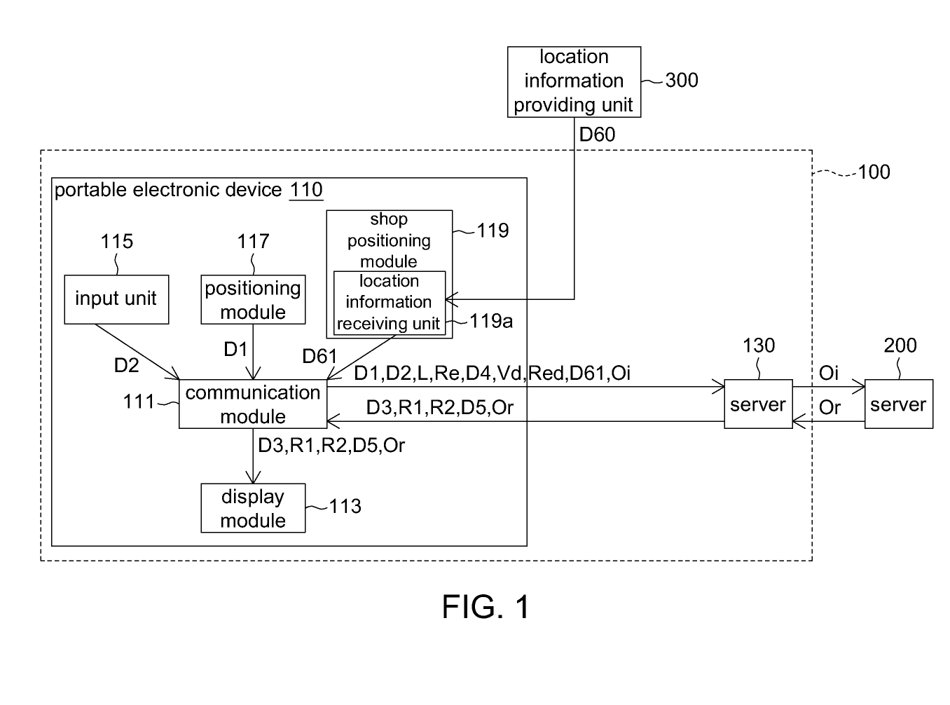

Referring to FIG. 1, a block diagram of a price comparison system according to an embodiment of the present invention is shown. The price comparison system 100 includes a portable electronic device 110 and a server 130. The portable electronic device 110 can be a mobile electronic device such as a personal digital assistant (PDA) or a mobile communication device. The portable electronic device 110 includes a communication module 111 and a display module 113.

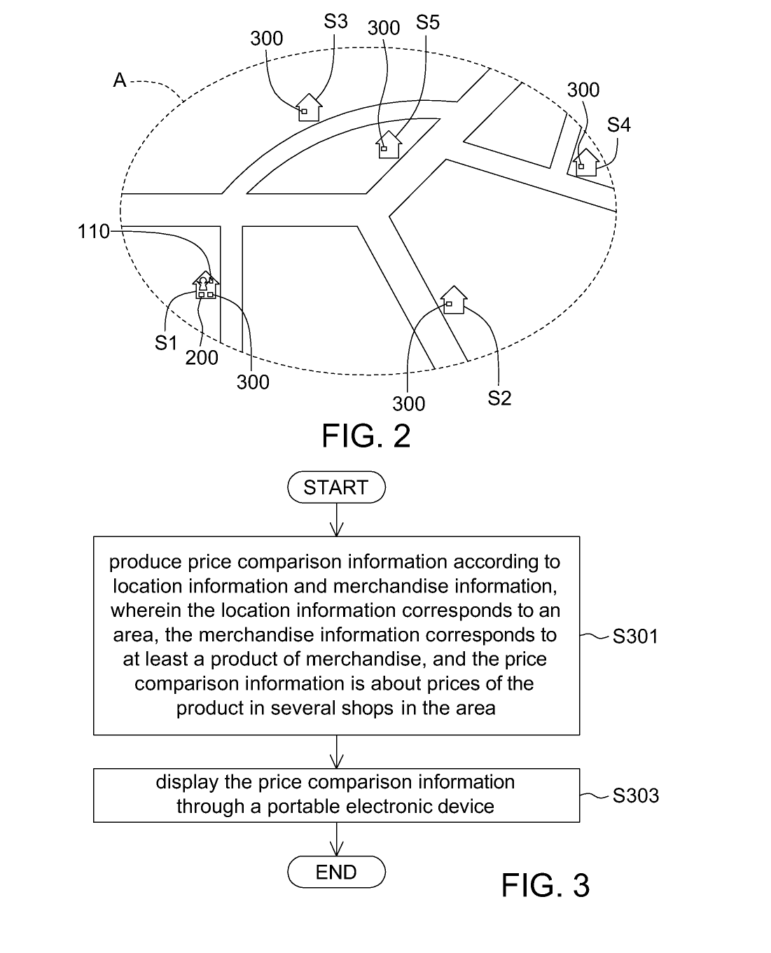

Suppose a user carrying the portable electronic device 110 is located in an area A shown in FIG. 2 and would like to know the price comparison information of a product of merchandise in several shops S1˜S5 in the area A. The user could transmit location information D1 corresponding to the area A and merchandise information D2 corresponding to the particular product of merchandise to the server 130 through the communication module 111. The server 130 produces price comparison information D3 according to the location information D1 and the merchandise information D2, and further transmits the price comparison information D3 to the communication module 111 through wireless transmission, so that the price comparison information D3 received through the communication module 111 could be shown by the display module 113.

Thus, the user could clearly and conveniently understand the price comparison information D3 of the particular product in the area A from the information displayed through the display module 113. Here, the price comparison information D3 is about the prices of the particular product in the shops in the area A.

In the present embodiment of the invention, the user could operate an input unit 115 of the portable electronic device 110 to produce the merchandise information D2 corresponding to the particular product. For example, the input unit 115 is, for example, a recognizer capable of recognizing a barcode, so that the merchandise information D2 is produced by scanning or capturing the image of the barcode of the particular product. Or, the input unit 115 is, for example, a keyboard, so that the merchandise information D2 is produced by inputting the numbers corresponding to the barcode of the particular product of merchandise.

The portable electronic device 110 could further include a positioning module 117. The location information D1 corresponding to the area A is obtained through the positioning module 117. The positioning module 117 detects a location of the portable electronic device 110 in the area A and produces the location information D1 corresponding to the location. However, the user could select an area that the user is interested in so as to obtain the price comparison information of the product of merchandise in the area. For example, the user could operate the input unit 115 such as a keyboard for producing the location information corresponding to the area that the user is interested in so as to obtain the price comparison information of the product in the area.

In addition, assume the user has a shopping list L including several products. The server 130 produces path guiding information R1 for the portable electronic device 110 according to the location in the area A of the product in the shopping list L and a starting-point. The path guiding information R1 shows or is about a path between the starting-point and the location. It's noted that the meaning herein of the path guiding information showing the path can be, e.g., the path guiding information gives advice or instruction about, or points out the path. The location of the product in the area A could be obtained from the inventory list of the merchandise available in a shop and transmitted to the server 130 in advance. The starting-point could be a location predetermined by the user or the location of the portable electronic device 110 corresponding to the location data D1. Thus, the user could purchase the product in the shopping list L according to the path guiding information R1. When the user is not satisfied with the path corresponding to the path guiding information R1, the server 130 is further used for producing another path guiding information R2 for the portable electronic device 110 for reference according to planned path information Re transmitted from the portable electronic device 110, the location of the product and the starting-point. The path guiding information R2 shows or is about a path between the starting-point and the location.

In addition to obtaining the price comparison information D3 through the merchandise information D2 corresponding to the merchandise, the user could specifically target the merchandise available in a particular shop. The server produces merchandise information D5 of the shop to the portable electronic device 110 according to shop information D4 transmitted from the portable electronic device 110, so that the user can further understand the data of the product in the particular shop.

Assume the user is in the shop S1 shown in FIG. 2 and finds out that the price comparison information D3 provided by the server 130 does not conform to the actual merchandise price, the user could update the data stored in the server 130. To avoid the data stored in the server 130 being arbitrarily falsified or altered, the server 130 could receive verification data Vd from the portable electronic device 110 and determine whether the verification data Vd conforms to pre-set data as a mechanism for determining whether to update the information. If the server 130 determines that the verification data Vd conforms to the pre-set data, the server 130 update the corresponding merchandise information according to update information Red received from the portable electronic device 110.

Moreover, in order to allow the user to conveniently update the merchandise information, the shops S1˜S5 in the area A are respectively equipped with several location information providing units 300. The portable electronic device 110 further includes a shop positioning module 119 for detecting a shop location of one of the shops where the portable electronic device 110 is. The shop location corresponds to shop information D61 of the shop where the portable electronic device 110 is. That is, the shop location of the shop where the portable electronic device 110 is corresponds to the shop information D61 of the shop. The shop positioning module 119 includes a location information receiving unit 119a. In the following descriptions, the portable electronic device 110 is, for example, located in the shop S1. When the portable electronic device 110 is closer or more adjacent to the location information providing unit 300 in the shop S1 than to the rest of the location information providing units 300 due to the portable electronic device's 110 being in the shop S1, the location information providing unit 300 in the shop S1 provides positioning information D60 corresponding to the shop location to the location information receiving unit 119a for producing shop information D61. The server 130 further updates the merchandise information according to the shop information D61 and the update information Red. In other words, as indicated in FIG. 2, the user is in the shop S1, and the server 130 is informed through the location information providing unit 300 disposed in the shop S1 in advance that the user has already entered the shop S1. Thus, when the user updates the merchandise information, the server 130 directly updates the merchandise information of the shop S1 where the user is according to the update information Red.

To increase the effectiveness in marketing, the vendor could transmit the merchandise information to the server 130 for allowing the user to conveniently obtain the merchandise information. Or, Internet shops which dispense with a physical shop can trade with their clients through the price comparison system 100 of the present embodiment of the invention. For example, the server 130 is further used for transmitting order information Oi transmitted from the portable electronic device 110 to the server 200 in the shop. Thus, the vendor can respond according to the inventory state. That is, response information Or from the server 200 in the shop can be transmitted to the portable electronic device 110 via the server 130 for allowing the user to understand whether the product is available in the shop.

In the present embodiment of the invention, the response information Or corresponds to the order information Oi.

The present invention further provides a price comparison method as indicated in FIG. 3. The price comparison method includes the following steps. Firstly, in the step S301, price comparison information is produced according to location information and merchandise information, wherein the location information corresponds to an area, the merchandise information corresponds to at least a product of merchandise, and the price comparison information is about prices of the product of merchandise in several shops in the area. Next, in the step S303, the price comparison information is displayed through a portable electronic device.

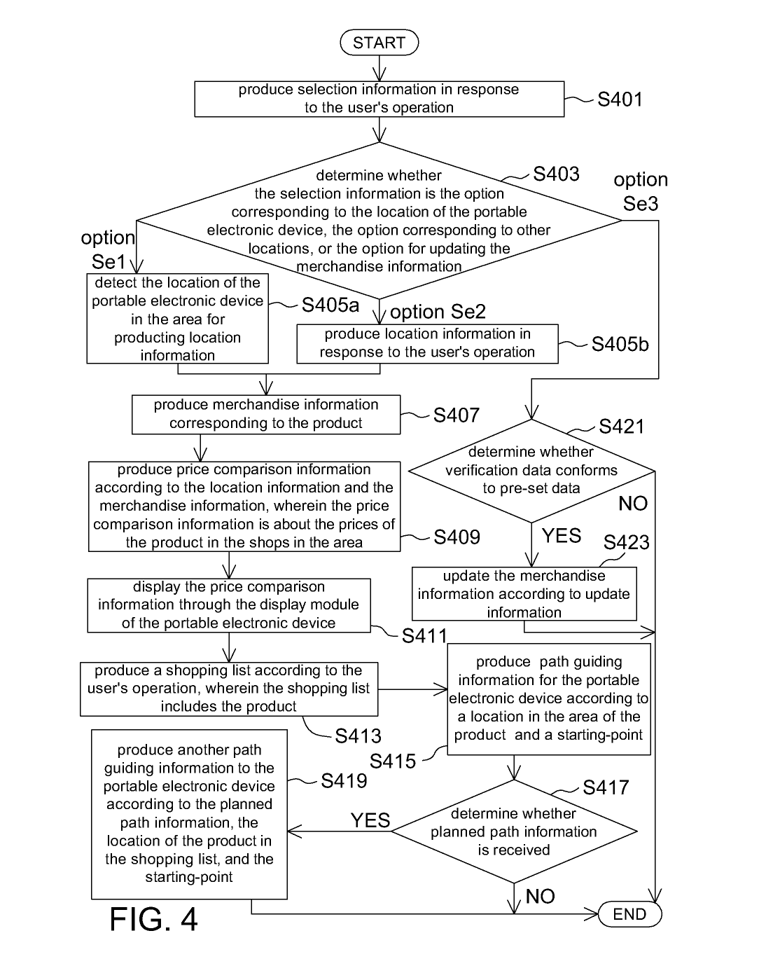

Referring to FIG. 4, a flowchart of a price comparison method according to an embodiment of the present invention is shown. The price comparison method of the present embodiment of the invention performs each step in FIG. 4 through the price comparison system 100 in FIG. 1, but the present invention is not limited thereto. A person having ordinary skills in the art of the invention will understand that the steps and the sequence of the steps of the price comparison method can be modified or adjusted to fit actual needs.

In the step S401, the portable electronic device 110 produces selection information in response to the user's operation.

Then, in the step S403, whether the selection information is the option Se1 corresponding to the location of the portable electronic device 110, the option Se2 corresponding to other locations, or the option Se3 for updating the merchandise information is determined. When it is determined that the selection information is the option Se1 corresponding to the location of the portable electronic device 110, the price comparison method of the present embodiment of the invention proceeds to the step S405a. When it is determined that the selection information is the option Se2 corresponding to other locations, the price comparison method of the present embodiment of the invention proceeds to the step S405b. When it is determined that the selection information is the option Se3 for updating the merchandise information, the price comparison method of the present embodiment of the invention proceeds to the step S421.

The associated steps when the selection information is the option Se1 corresponding to the location of the portable electronic device 110 or the option Se2 corresponding to other locations are elaborated first. When the selection information is the option Se1 corresponding to the location of the portable electronic device 110, the positioning module 117 detects the location of the portable electronic device 110 in the area for producing the location information (step S405a) corresponding to the location. When the selection information is the option Se2 corresponding to other locations, the location information is produced according to the user's operation (step S405b), such as inputting the address of other location, clicking an area on the map, or selecting the area selection provided by the portable electronic device 110.

Following the step S405a and the step S405b, the step S407 is performed. In the step S407, the input unit 115 of the portable electronic device 110 produces merchandise information which corresponds to the product. The input unit 115 produces the merchandise information according to the barcode of the merchandise, for example. Or, the input unit 115 produces the merchandise information through the user's input.

Afterwards, in the step S409, the server 130 produces price comparison information according to the location information and the merchandise information. The price comparison information is about the prices of the product in the shops in the area. The area refers to the corresponding area of the location where the portable electronic device 110 is or the corresponding area of the location information produced according to the user's operation.

After that, in the step S411, the price comparison information is displayed through the display module 113 of the portable electronic device 110 for reference.

Following that, in the step S413, the portable electronic device 110 produces a shopping list according to the user's operation, wherein the shopping list includes the product.

Next, in the step S415, the server 130 produces path guiding information for the portable electronic device 110 according to a location in the area of the product and a starting-point. The path guiding information shows or is about a path between the starting-point and the location of the product. The communication module 111 receives the path guiding information. However, the starting-point can be a location set by the user or the location of the portable electronic device 110 corresponding to the location data.

Then, in the step S417, the server 130 determines whether planned path information is received. If no, the price comparison method of the present embodiment of the invention terminates; if yes, the method proceeds to the step S419. In the step S419, the server 130 produces another path guiding information to the portable electronic device 110 for reference according to the planned path information, the location of the product in the shopping list, and the starting-point.

The associated steps when the selection information is the option Se3 for updating the merchandise information are elaborated below. When the selection information is the option Se3 for updating the merchandise information, the price comparison method of the present embodiment of the invention proceeds to the step S421. In the step S421, the server 130 determines whether verification data transmitted from the portable electronic device 110 conforms to pre-set data. If no, the price comparison method of the present embodiment of the invention terminates; if yes, the method proceeds to the step S423. In the step S423, the server 130 updates the merchandise information according to update information.

To further increase the convenience in operation, after the step S421, the method could further include the following steps. When the portable electronic device 110 is closer or more adjacent to one than to the rest of the location information providing units 300, the closest location information providing unit 300 provides positioning information to the location information receiving unit 119a of the shop positioning module 119. The positioning information corresponds to a shop location of the shop where the portable electronic device 110 is. Then, the location information receiving unit 119a produces shop information of the shop. Next, in the step S423, the merchandise information is updated according to the shop information and the update information.

However, the price comparison method of the present embodiment of the invention could further include a step of producing and transmitting shop information to the server 130 according to the user's operation. The server 130 produces merchandise information of the shop to the portable electronic device 110 according to the shop information, so that the user can understand the kinds and prices of the product available in particular shops. Or, the price comparison method of the present embodiment of the invention could further include the step of producing and transmitting order information to the server 200 in the shop according to the user's operation. Based on the inventory state, the shop can transmit the response information to the portable electronic device 110 through the server 130, wherein the response information corresponds to the order information.

The portable electronic device and the price comparison system and method using the same disclosed in the above embodiments of the invention provide the consumer with the price comparison information of the merchandise in each shop in a designated area. Thus, the consumer's time spent on comparing the prices can be effectively saved. In terms of the shops, the present embodiment of the invention also provides benefits of advertisement and marketing.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A price comparison system, comprising:
a portable electronic device, comprising:
a communication module used for transmitting location information and merchandise information and for receiving price comparison information; and
a display module used for displaying the price comparison information; and
a server used for producing the price comparison information according to the location information and the merchandise information, and for transmitting the price comparison information to the communication module through wireless transmission;
wherein the location information corresponds to an area, the merchandise information corresponds to at least a product of merchandise, and the price comparison information is about prices of the product of merchandise in a plurality of shops in the area.

2. The price comparison system according to claim 1, wherein the server is further used for producing path guiding information for the portable electronic device according to a location in the area of the product in a shopping list and a starting-point, wherein the path guiding information shows or is about a path between the starting-point and the location.

3. The price comparison system according to claim 2, wherein the server is further used for producing another path guiding information for the portable electronic device according to planned path information transmitted by the portable electronic device, the location of the product and the starting-point, and said another path guiding information shows or is about a path between the starting-point and the location.

4. A portable electronic device used for communicating with a server, wherein the portable electronic device comprises:
a communication module used for transmitting location information and merchandise information and for receiving price comparison information, wherein the price comparison information is produced by the server according to the location information and the merchandise information; and
a display module used for displaying the price comparison information;
wherein, the location information corresponds to an area, the merchandise information corresponds to at least a product of merchandise, and the price comparison information is about prices of the product of merchandise in a plurality of shops in the area.

5. The portable electronic device according to claim 4, further comprising:
a positioning module used for detecting a location of the portable electronic device in the area and for producing the location information corresponding to the location.

6. The portable electronic device according to claim 4, further comprising:
an input unit used for producing the location information in response to operating the input unit.

7. The portable electronic device according to claim 4, further comprising:
an input unit used for producing the merchandise information according to a barcode of the product of merchandise.

8. The portable electronic device according to claim 4, wherein the communication module is further used for receiving path guiding information, the path guiding information is produced by the server according to a location in the area of the product in a shopping list and a starting-point, and the path guiding information shows or is about a path between the starting-point and the location of the product.

9. The portable electronic device according to claim 8, wherein the communication module is further used for transmitting planned path information, and information of both the location of the product and the starting-point to the server, and for receiving another path guiding information from the server, and said another path guiding information shows or is about a path between the starting-point and the location of the product and is produced by the server according to the planned path information, the location in the area of the product, and the starting-point.

10. The portable electronic device according to claim 4, wherein the communication module is further used for transmitting information of a shop and for receiving merchandise information of the shop produced by the server according to the shop information.

11. The portable electronic device according to claim 4, wherein the communication module is further used for transmitting verification data to the server, and the server determines whether the verification data conforms to pre-set data;
wherein if the server determines that the verification data conforms to the pre-set data, the communication module transmits update information to the server, for the server to update the merchandise information corresponding to the portable electronic device.

12. The portable electronic device according to claim 11, wherein the shops are respectively equipped with a plurality of location information providing units, and the portable electronic device further comprises:
a shop positioning module used for detecting a shop location of one of the shops where the portable electronic device is, wherein the shop location corresponds to shop information of the shop where the portable electronic device is, the shop positioning module comprises a location information receiving unit, and when the portable electronic device is closer to one than to the rest of the location information providing units, the one of the location information providing units provides positioning information corresponding to the shop location to the location information receiving unit for producing the shop information;
wherein, the server is further used to update the merchandise information according to the shop information and the update information.

13. The portable electronic device according to claim 4, wherein the communication module is further used for transmitting order information to the server, and then the server transmits the order information to another server.

14. The portable electronic device according to claim 13, wherein the communication module is further used for receiving response information from the server, the response information is transmitted to the server from said another server, and the response information corresponds to the order information.

15. A price comparison method, comprising:
producing price comparison information according to location information and merchandise information, wherein the location information corresponds to an area, the merchandise information corresponds to at least a product of merchandise, and the price comparison information is about prices of the product in a plurality of shops in the area; and
displaying the price comparison information through a portable electronic device.

16. The price comparison method according to claim 15, further comprising:
detecting a location of the portable electronic device in the area for producing the location information corresponding to the location.

17. The price comparison method according to claim 15, further comprising:
producing path guiding information for the portable electronic device according to a location in the area of the product in a shopping list and a starting-point, wherein the path guiding information shows or is about a path between the starting-point and the location of the product.

18. The price comparison method according to claim 17, further comprising:
producing another path guiding information for the portable electronic device according to planned path information, the location of the product in the shopping list and the starting-point, wherein said another path guiding information shows or is about a path between the starting-point and the location of the product.

19. The price comparison method according to claim 15, further comprising:
determining whether verification data conforms to pre-set data; and
updating the merchandise information according to update information, if it is determined that the verification data conforms to the pre-set data.

20. The price comparison method according to claim 19, wherein the shops are respectively equipped with a plurality of location information providing units, and the price comparison method further comprises:
one of the location information providing units providing positioning information to a location information receiving unit of the portable electronic device when the portable electronic device is closer to the one than to the rest of the location information providing units, wherein the positioning information corresponds to a shop location of one of the shops where the portable electronic device is;
the location information receiving unit producing shop information of the shop where the portable electronic device is; and
updating the merchandise information according to the shop information and the update information.
